(19) United States
(12) Patent Application Publication
(10) Pub. No.: US 2021/0261070 A1
(43) Pub. Date: Aug. 26, 2021

(54) SENSOR MOUNTING STRUCTURE FOR A VEHICLE

(71) Applicant: TOYOTA JIDOSHA KABUSHIKI KAISHA, Aichi-ken (JP)

(72) Inventors: Tomoki MATSUMURA, Toyota-shi (JP); Kazuhisa MAEDA, Toyota-shi (JP); Hideo TAKEDA, Hekinan-shi (JP)

(21) Appl. No.: 17/158,008

(22) Filed: Jan. 26, 2021

(30) Foreign Application Priority Data
Feb. 20, 2020 (JP) 2020-027206

(51) Int. Cl. B60R 11/04

(52) U.S. Cl. CPC B60R 11/04; B60R 2011/004

(57) ABSTRACT

A sensor mounting structure for a vehicle is provided with an external plate component that is formed so as to be mountable on and removable from a vehicle, and that forms a portion of the vehicle, and with a sensor that is provided at the external plate component, and that detects a peripheral status of the vehicle.

### CROSS-REFERENCE TO RELATED APPLICATION

This application is based on and claims priority under 35 USC 119 from Japanese Patent Application No. 2020-27206 filed on Feb. 20, 2020, the disclosure of which is incorporated by reference herein.

### BACKGROUND

### Technical Field

The present disclosure relates to a sensor mounting structure for a vehicle.

### Related Art

An interchangeable-body vehicle in which one body that is selected from a group of multiple bodies is mounted on the same vehicle chassis body is known conventionally (see, for example, Japanese Unexamined Patent Application Laid-Open (JP-A) No. 2015-98186.

Sensors that are provided in vehicles are becoming progressively smaller in size and more functional (i.e., demonstrate constantly improving performance) almost by the day. Consequently, from the viewpoints of improving the appearance of a vehicle and improving vehicle safety, it is preferable that a vehicle be equipped with the very latest sensors. However, in order to equip a vehicle with the latest sensors, it is necessary to either buy an entire new vehicle, or to modify a part of the design that is a major factor in contributing to the exterior appearance of the vehicle, and both these options place a considerable burden on users.

### SUMMARY

It is, therefore, an object of the present disclosure to provide a sensor mounting structure for a vehicle that enables a sensor to be replaced without the vehicle itself having to be replaced.

In order to achieve the above-described object, a sensor mounting structure for a vehicle according to a first aspect is provided with an external plate component that is formed so as to be mountable on and removable from a vehicle, and that forms a portion of the vehicle, and with a sensor that is provided at the external plate component, and that detects a peripheral status of the vehicle.

According to this invention, a sensor that detects a peripheral status of a vehicle is provided at an external plate component that forms a portion of the vehicle, and this external plate component is formed so as to be mountable on and removable from the vehicle. Accordingly, when replacing the sensor, it is only necessary to remove this external plate component from the vehicle and then replace it. In this way, according to the present disclosure, it is possible to replace a sensor without the vehicle itself having to be replaced.

A sensor mounting structure for a vehicle according to a second aspect is characterized in that, in the sensor mounting structure for a vehicle according to the first aspect, the sensor is embedded in the external plate component.

According to this invention, the sensor is embedded in the external plate component. Accordingly, when replacing the sensor, this can be achieved by replacing the entire external plate component so that the burden on the person performing the replacement is alleviated.

A sensor mounting structure for a vehicle according to a third aspect is characterized in that, in the sensor mounting structure for a vehicle according to the first or second aspects, the external plate component is formed from a resin material.

According to this invention, the external plate component is formed from a resin material. Accordingly, compared to when the external plate component is formed from metal, an increase in the weight of the vehicle can be inhibited.

A sensor mounting structure for a vehicle according to a fourth aspect is characterized in that, in the sensor mounting structure for a vehicle according to any one of the first through third aspects, the external plate component configures any one of a side member outer panel provided in a roof side-rail, a portion of a roof, or a portion of a hood.

According to this invention, the external plate component configures any one of a side member outer panel provided in a roof side-rail, a portion of a roof, or a portion of a hood. In other words, no component that might be an obstruction between the sensor and the periphery thereof exists in the location where the sensor is provided. Accordingly, the peripheral status of the vehicle can be accurately detected by that sensor.

As has been described above, according to the present disclosure, it is possible to replace a sensor without the vehicle itself having to be replaced.

### BRIEF DESCRIPTION OF THE DRAWINGS

Exemplary embodiments of the present disclosure will be described in detail based on the following figures, wherein:

FIG. 1 is a side view showing a vehicle provided with a sensor mounting structure according to a first exemplary embodiment;

FIG. 2 is a cross-sectional view taken across a line X-X in FIG. 1;

FIG. 3 is a side view showing a vehicle provided with a sensor mounting structure according to a second exemplary embodiment;

FIG. 4 is a cross-sectional view taken across a line Y-Y in FIG. 3; and

FIG. 5 is a side view showing a vehicle provided with a variant example of a sensor mounting structure according to the second exemplary embodiment.

### DETAILED DESCRIPTION

Hereinafter, exemplary embodiments according to the present disclosure will be described in detail based on the drawings. Note that an arrow UP, an arrow FR, and an arrow LH that are shown in the appropriate drawings respectively indicate a vehicle upward direction, a vehicle forward direction, and a vehicle left-side direction. Hereinafter, if front-rear, left-right, or up-down directions are used in the following description, then, unless specifically stated otherwise, these refer respectively to the front-rear directions of the vehicle, the left-right directions of the vehicle (i.e., width direction of the vehicle) relative to a direction of forward travel, and the up-down directions of the vehicle. In addition, if component elements are described using the same symbols in the drawings, then this means that these component elements are either the same as or similar to each other. Note also that duplicated descriptions and symbols in the respective exemplary embodiments described below may, in some cases, be omitted.

### FIRST EXEMPLARY EMBODIMENT

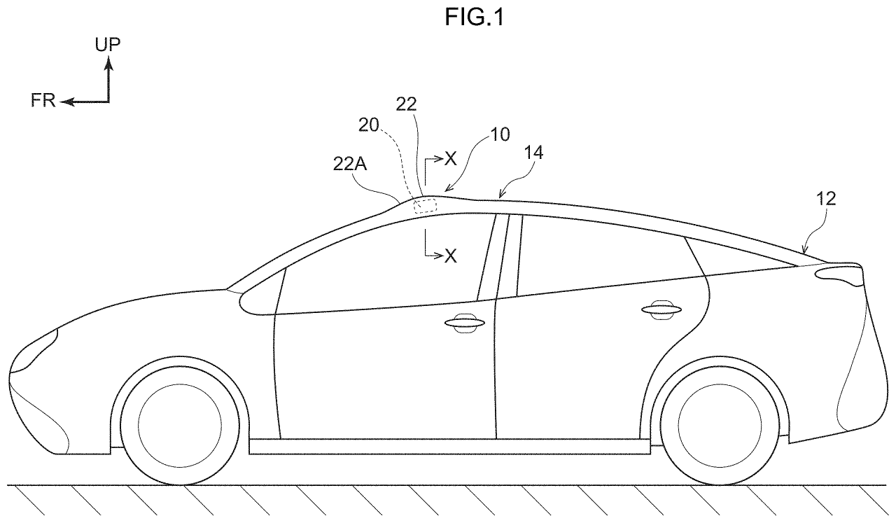

Firstly, a sensor mounting structure 10 for a vehicle according to a first exemplary embodiment will be described. As is shown in FIG. 1, in this first exemplary embodiment, a sensor 20 that detects a peripheral status of a vehicle 12 is provided in a side member outer panel 22 which is serving as an external plate component. A side member outer panel 22 is attached respectively to an outer side in the width direction of the vehicle of each of a left and a right roof side-rail 14 of the vehicle 12.

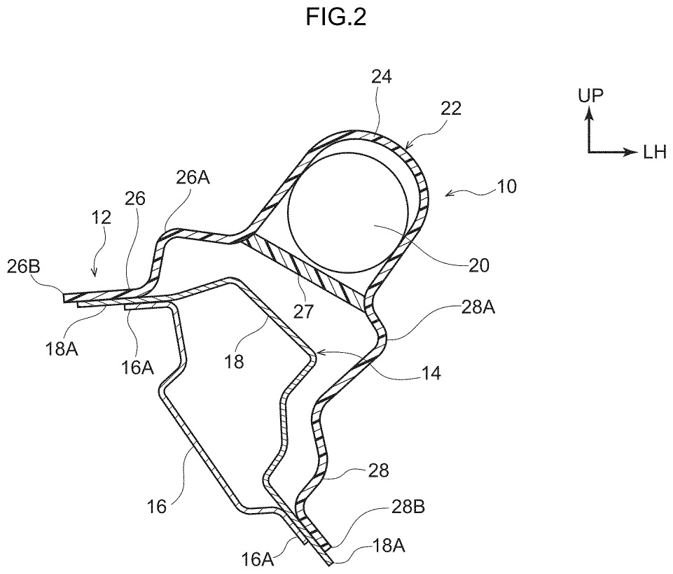

More specifically, as is shown in FIG. 2, each roof side-rail 14 is formed by joining together respective flange portions 16A and 18A of a rail inner reinforcement 16 which is made from metal and a rail outer reinforcement 18 which is also made from metal. In other words, a closed cross-sectional configuration extending in the front-rear direction is formed by the rail inner reinforcement 16 and the rail outer reinforcement 18.

The side member outer panels 22 are formed from a resin material, and are mounted on an outer side in the width direction of the vehicle of the respective roof side-rails 14 in such a way that they can be detached therefrom and reattached thereto. This resin material is not particularly restricted and examples of resins that may be used include carbon fiber reinforced resin materials (CFRP), glass fiber reinforced resin materials (GFRP), acrylonitrile/ethylene-propylene diene/styrene (AES), acrylonitrile/butadiene/styrene (ABS), polycarbonate (PC), and polypropylene (PP).

Moreover, the side member outer panels 22 are formed substantially in an inverted U shape when looked at from the front side thereof, and are provided with an apex portion 24 which has a substantially circular-arc shaped cross-section and which protrudes upwards and towards the outer side in the width direction of the vehicle, and with an inner-side flange portion 26 and a lower-side flange portion 28 that extend respectively towards the inner side in the width direction of the vehicle and towards the lower side from the apex portion 24.

Step portions 26A and 28A are formed respectively on the inner-side flange portion 26 and the lower-side flange portion 28 so as to respectively widen the aperture (more specifically, on distal end portions 26B and 28B sides thereof). The distal end portions 26B and 28B of the inner-side flange portion 26 and the lower-side flange portion 28 are superimposed on the rail outer reinforcement 18, and are joined thereto by means of an adhesive agent or the like in such a way that they can be detached therefrom and reattached thereto.

The sensors 20 that are provided on the left and right sides are formed, for example, in a circular column shape, and are housed respectively on the inside of the apex portion 24 of each side member outer panel 22. In other words, an inner diameter of the apex portion 24 of each side member outer panel 22 is formed slightly larger than an outer diameter of the sensors 20, and the sensors 20 are able to be housed inside the apex portion 24 of each side member outer panel 22 such that they extend in the front-rear direction.

After the sensors 20 have been housed within the apex portion 24, a lid body 27 that is formed, for example, from resin is provided so as to extend between a base of the step portion 26A of the inner-side flange portion 26 (in other words, a boundary portion between the apex portion 24 and the inner-side flange portion 26), and a base of the step portion 28A of the lower-side flange portion 28 (in other words, a boundary portion between the apex portion 24 and the lower-side flange portion 28). The apex portion 24 is closed off by this lid body 27 so that, as a result, the sensors 20 cannot be seen from the outside. In other words, the sensors 20 are embedded within the interior of the side member outer panels 22 whose cross-sections are formed substantially in an inverted U shape.

Note that a cable (not shown in the drawings) that is connected to the sensors 20 extends to the outside via a through hole or a notch portion (neither is shown in the drawings) formed in the lid body 27. Moreover, it is also possible to employ a structure in which the interior of the apex portion 24 of the side member outer panel 22 is filled with an elastic body such as urethane or the like (not shown in the drawings), so that the periphery of the sensors 20 is protected by this elastic body.

In addition, it is also possible to appropriately modify the configuration of the apex portion 24 in the side member outer panel 22 so that this configuration matches the configuration of the sensors 20. However, as is shown in FIG. 1, a front portion of the side member outer panel 22 is formed, for example, as an inclined surface 22A which slopes gently upwards, and the sensors 20 are disposed in the uppermost position of the roof side rails 14. Moreover, in order to increase the transmittance of the electric waves emitted from the sensors 20, it is also possible to form a mesh configuration (not shown in the drawings) in the inclined surface 22A of the side member outer panel 22.

Next, actions of the sensor mounting structure 10 for a vehicle according to the first exemplary embodiment having the above-described structure will be described.

As is shown in FIG. 1 and FIG. 2, sensors 20 that detect a peripheral status of the vehicle 12 are housed respectively inside the apex portion 24 of each of the left and right side member outer panels 22 that are attached to the outer sides in the width direction of the vehicle of the left and right roof side rails 14. Here, because there are no seams in the side member outer panels 22 housing the sensors 20, there is no possibility of moisture penetrating the sensors 20.

The positions where the sensors 20 are provided are, for example, the uppermost positions in the roof side rails 14. In other words, no component (excluding the side member outer panels 22) is able to become an obstacle between the sensors 20 and their surroundings. Accordingly, using these sensors 20, it is possible to accurately detect the peripheral status of the vehicle 12.

Moreover, each side member outer panel 22 is removably attached to the respective rail outer reinforcement 18. Accordingly, when upgrading to the latest model of a sensor (not shown in the drawings), the side member outer panels 22 can be removed from the rail outer reinforcements 18 and the replacement can then be made. In other words, it is possible to replace the sensors 20 with the latest model of sensor without having to replace the entire vehicle 12 itself (or exchange the vehicle body), or having to reform the design portions that provide the external appearance of the vehicle. Accordingly, the safety of the vehicle 12 can be easily improved.

In addition, if a structure in which the sensors 20 are embedded in the side member outer panels 22 (in other words, if a structure in which the lid 27 cannot be removed) is used, then because the sensor replacement task can be accomplished simply by replacing the entire side member outer panel 22, the load on a replacement task operator such as a mechanic at a vehicle dealership can be alleviated. Furthermore, because the side member outer panels 22 are formed from resin, compared with when the side member outer panels 22 are formed from metal, an increase in the weight of the vehicle 12 can be inhibited, and the possibility of injury in the event of a collision can be reduced.

Moreover, the front portion of each side member outer panel 22 is formed as the inclined surface 22A which slopes gently upwards. Accordingly, even though the structure is one in which the side member outer panels 22 containing the built-in sensors 20 are provided on the outer sides in the width direction of the vehicle of the roof side rails 14, there is no concern that the attractive appearance of the vehicle 12 will be diminished, and it is also possible to inhibit an increase in wind resistance when the vehicle 12 is traveling. In other words, according to the sensor mounting structure 10 for a vehicle according to the present exemplary embodiment, it is possible to achieve both functionality and an attractive appearance.

### SECOND EXEMPLARY EMBODIMENT

Next, a sensor mounting structure 10 for a vehicle according to a second exemplary embodiment will be described. Note that the same descriptive symbols are used to describe component elements that are the same as in the first exemplary embodiment, and a detailed description thereof (including of common actions) is omitted when this is appropriate.

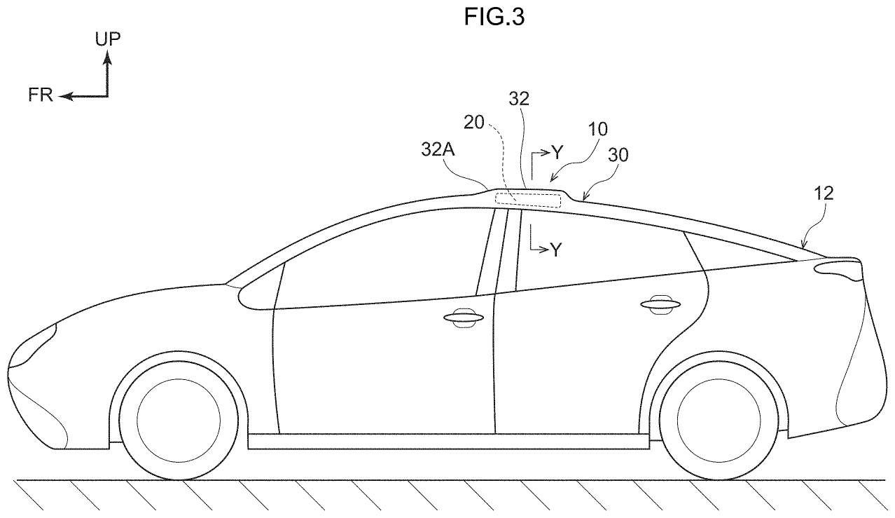

As is shown in FIG. 3, in this second exemplary embodiment, a single sensor 20 that detects the peripheral status of the vehicle 12 is provided in a roof sub panel 32 which serves as an outer plate component, and that is attached to a central portion in the width direction of the vehicle of a roof (more specifically, a roof panel) 30 of the vehicle 12. The roof sub panel 32 that forms a portion of the roof 30 is formed from the same resin material as in the first exemplary embodiment, and is removably attached to the central portion in the width direction of the vehicle of the roof 30.

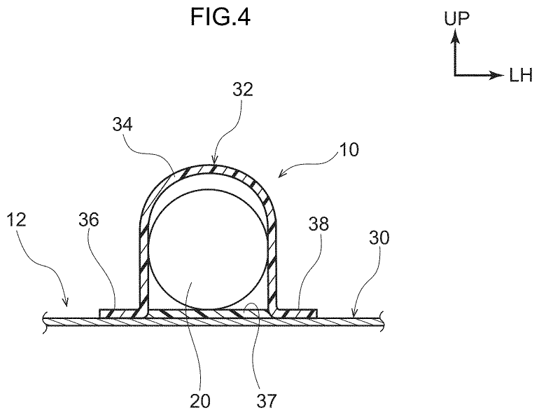

More specifically, as is shown in FIG. 4, the roof sub panel 32 is formed having a substantially inverted U shaped cross-section when looked at from the front, and is provided with an apex portion 34 which has a substantially circular-arc shaped cross-section and which protrudes upwards, and with a right-side flange portion 36 and a left-side flange portion 38 that extend respectively towards the outer side in the width direction of the vehicle from the apex portion 34. The right-side flange portion 36 and the left-side flange portion 38 are superimposed on the roof 30, and are joined thereto by means of an adhesive agent or the like in such a way that they can be detached therefrom and reattached thereto.

This single sensor 20 is housed in the inside of the apex portion 34 of the roof sub panel 32. In other words, an inner diameter of the apex portion 34 of the roof sub panel 32 is formed slightly larger than the outer diameter of the sensor 20, and the sensor 20 is able to be housed inside the apex portion 34 of the roof sub panel 32 so as to extend in the front-rear direction.

After the sensor 20 has been housed within the apex portion 34, a lid body 37 that is formed from resin is provided so as to extend between a base of the right-side flange portion 36 (in other words, a boundary portion between the apex portion 34 and the right-side flange portion 36), and a base of the left-side flange portion 38 (in other words, a boundary portion between the apex portion 34 and the left-side flange portion 38), and the apex portion 34 is closed off by this lid body 37 so that the sensor 20 cannot be seen from the outside. In other words, the sensor 20 is embedded within the interior of the roof sub panel 22 whose cross-section is formed substantially in an inverted U shape.

Note that a cable (not shown in the drawings) that is connected to the sensor 20 extends to the outside via a through hole or a notch portion (neither is shown in the drawings) formed in the lid body 37. Moreover, it is also possible to employ a structure in which the interior of the apex portion 34 of the roof sub panel 32 is filled with an elastic body such as urethane or the like (not shown in the drawings), so that the periphery of the sensor 20 is protected by this elastic body.

In addition, it is also possible to appropriately modify the configuration of the apex portion 34 in the roof sub panel 32 so that this configuration matches the configuration of the sensor 20. However, as is shown in FIG. 3, a front portion of the roof sub panel 32 is formed as an inclined surface 32A which slopes gently upwards, and the sensor 20 is disposed in the uppermost position on the roof 30. Moreover, in order to increase the transmittance of the electric waves emitted from the sensor 20, it is also possible to form a mesh configuration (not shown in the drawings) in the inclined surface 32A of the roof sub panel 32.

Next, actions of the sensor mounting structure 10 for a vehicle according to the second exemplary embodiment having the above-described structure will be described.

As is shown in FIG. 3 and FIG. 4, a sensor 20 that detects a peripheral status of the vehicle 12 is housed inside the apex portion 34 of the roof sub panel 32 that is attached to the central portion in the width direction of the vehicle of the roof 30. Here, because there are no seams in the roof sub panel 32 housing the sensor 20, there is no possibility of moisture penetrating the sensor 20.

The position where the sensor 20 is provided is the uppermost position in the roof 30. As a consequence, this prevents any component (excluding the roof sub panel 32) from becoming an obstacle between the sensor 20 and its surroundings. Accordingly, using this sensor 20 it is possible to accurately detect the peripheral status of the vehicle 12.

Moreover, the roof sub panel 32 is removably attached to the roof 30. Accordingly, when upgrading to the latest model of a sensor (not shown in the drawings), the roof sub panel 32 can be removed from the roof 30 and the replacement can then be made. In other words, it is possible to replace the sensor 20 with the latest model of sensor without having to replace the entire vehicle 12 itself or exchange the vehicle body, or having to reform the design portions that provide the external appearance of the vehicle. Accordingly, the safety of the vehicle 12 can be easily improved.

In addition, if a structure in which the sensor 20 is embedded in the roof sub panel 32 (in other words, if a structure in which the lid 37 cannot be removed) is used, then because the sensor replacement task can be accomplished simply by replacing the roof sub panel 32, the load on a replacement task operator such as a mechanic at a vehicle dealership can be alleviated. Furthermore, because the roof sub panel 32 is formed from resin, compared with when the roof sub panel 32 is formed from metal, an increase in the weight of the vehicle 12 can be inhibited, and the possibility of injury in the event of a collision can be reduced.

Moreover, the front portion of the roof sub panel 32 is formed as the inclined surface 32A which slopes gently upwards. Accordingly, even though the structure is one in which the roof sub panel 32 containing the built-in sensor 20 is provided in the central portion in the width direction of the vehicle of the roof 30, there is no concern that the attractive appearance of the vehicle 12 will be diminished, and it is also possible to inhibit an increase in wind resistance when the vehicle 12 is traveling.

### VARIANT EXAMPLE

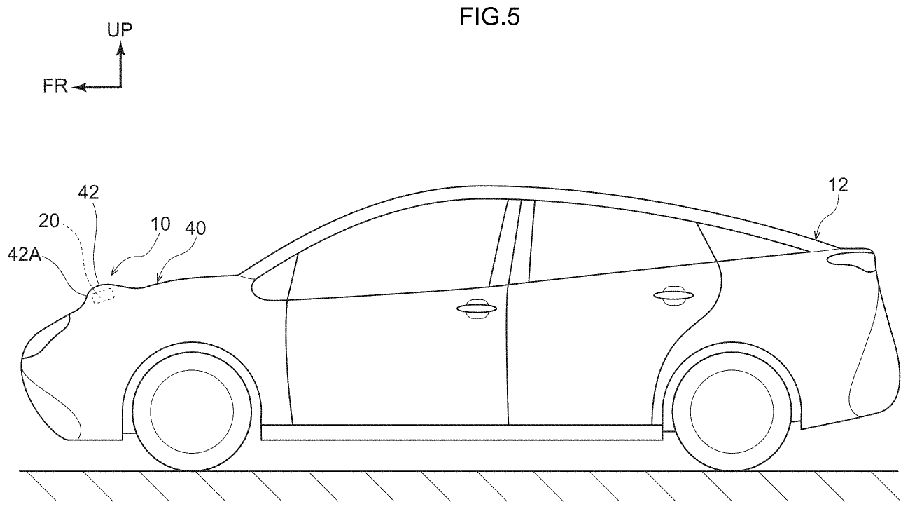

Note that, as is shown in FIG. 5, it is also possible to provide a single sensor 20 which detects the peripheral status of the vehicle 12 in a hood sub panel 42 that is serving as an outer plate component that is attached to a central portion in the width direction of the vehicle of a hood (i.e., a hood panel) 40 of the vehicle 12. This hood sub panel 42 which forms a part of the hood 40 has the same structure as the roof sub panel 32 including having a front portion that has an inclined surface 42A which slopes gently upwards.

Accordingly, the actions performed when mounting the sensor 20 in the hood sub panel 42 are substantially the same as the above-described actions performed when mounting the sensor 20 in the roof sub panel 32. Note that because the sensor 20 in this case is not disposed in the uppermost position of the hood 40, but is instead disposed in a front end portion of the hood 40, there is no component (excluding the hood sub panel 42) that might obstruct the periphery of the sensor 20. Accordingly, using this sensor 20 it is possible to accurately detect the peripheral status of the vehicle 12.

The sensor mounting structure 10 for a vehicle according to the present exemplary embodiment has been described above based on the drawings, however, the sensor mounting structure 10 for a vehicle according to the present exemplary embodiment is not limited to the illustrated examples thereof, and various design modifications and the like may be made thereto insofar as they do not depart from the spirit or scope of the present disclosure. For example, the vehicle 12 may also be a MaaS (Mobility as a Service) vehicle as exemplified by a self-driving bus.

Moreover, the sensor 20 may also be a camera or the like. In particular, when the sensor 20 is a camera, then it is effective if the camera that is serving as the sensor 20 is disposed in the uppermost position of the vehicle 12. In addition, the exterior configuration of the sensor 20 is not limited to the circular column shape shown in the drawings, and the sensor 20 may also be formed, for example, in a regular polygonal column shape.

Exemplary embodiments of the present disclosure have been described above, however, the present disclosure is not limited to these. Various modifications and the like may be made to the present disclosure insofar as they do not depart from the spirit or scope of the present disclosure.

What is claimed is:

1. A sensor mounting structure for a vehicle, comprising:
an external plate component that is formed so as to be mountable on and removable from a vehicle, and that forms a portion of the vehicle; and
a sensor that is provided at the external plate component, and that detects a peripheral status of the vehicle.

2. The sensor mounting structure for a vehicle according to claim 1, wherein the sensor is embedded in the external plate component.

3. The sensor mounting structure for a vehicle according to claim 1, wherein the external plate component is formed from a resin material.

4. The sensor mounting structure for a vehicle according to claim 1, wherein the external plate component configures any one of a side member outer panel provided in a roof side-rail, a portion of a roof, or a portion of a hood.

5. The sensor mounting structure for a vehicle according to claim 4, wherein the sensor is provided at a highest position on the roof side-rail.

6. The sensor mounting structure for a vehicle according to claim 1, wherein:
the sensor is housed at an inner side of an apex portion of the external plate component, the apex portion protruding upwards and outwards in a width direction of the vehicle, and
the apex portion is closed by a lid body in a state in which the sensor is housed inside the apex portion.
